(19) United States
(12) Patent Application Publication
(10) Pub. No.: US 2021/0081739 A1
(43) Pub. Date: Mar. 18, 2021

(54) ARTICLE WITH WIRELESS COMMUNICATION DEVICE

(71) Applicant: Murata Manufacturing Co., Ltd., Nagaokakyo-shi (JP)

(72) Inventors: Hirokazu Yazaki, Nagaokakyo-shi (JP); Noriyuki Ueki, Nagaokakyo-shi (JP); Noboru Kato, Nagaokakyo-shi (JP)

(21) Appl. No.: 17/109,241

(22) Filed: Dec. 2, 2020

Related U.S. Application Data
(63) Continuation of application No. PCT/JP2019/014942, filed on Apr. 4, 2019.

(30) Foreign Application Priority Data
Aug. 17, 2018 (JP) 2018-153680

(51) Int. Cl. G06K 19/077; H01Q 7/00; H01Q 1/38

(52) U.S. Cl. CPC G06K 19/077; H01Q 1/38; H01Q 7/00

(57) ABSTRACT

An article is provided with a wireless communication device that is constructed to be attached to the article without using an adhesive. The article with the wireless communication device includes a wireless IC chip, a power feeding circuit board including a terminal electrode to which the wireless IC chip is connected, an article, and a conductive thread for attaching the power feeding circuit board to the article. The conductive thread contacts the terminal electrode and functions as a radiator while the power feeding circuit board is attached to the article.

### CROSS REFERENCE TO RELATED APPLICATIONS

The present application is a continuation of PCT/JP2019/014942 filed Apr. 4, 2019, which claims priority to Japanese Patent Application No. 2018-153680, filed Aug. 17, 2018, the entire contents of each of which are incorporated herein by reference.

### TECHNICAL FIELD

The present invention relates to an article with a wireless communication device.

### BACKGROUND ART

For example, a wireless communication device described in Patent Document 1 (identified below) is an example of a conventional wireless communication device. Patent Document 1 discloses a wireless communication device including a wireless IC chip, a power feeding circuit board having a terminal electrode to which the wireless IC chip is connected, and a radiation plate affixed or disposed close to the power feeding circuit board.

Patent Document 1: WO2007/083574.

In a conventional wireless communication device, an adhesive is usually used to fix a positional relationship between a radiation plate and a power feeding circuit board. If this wireless communication device is attached to an article, such as clothing that may get wet, this causes a problem that the material of the adhesive is limited.

Additionally, in a conventional wireless communication device, when the power feeding circuit board is attached to a thin linear or thread-shaped radiator instead of the radiation plate, a sufficient amount of adhesive cannot be arranged between the radiator and the power feeding circuit board, causing a problem that a connection failure easily occurs.

### SUMMARY OF THE INVENTION

Accordingly, it is an object of the exemplary embodiments of the present invention to provide an article with a wireless communication device in which the wireless communication device is attached to the article without using an adhesive.

To achieve the object, an article with a wireless communication device is provided according to an exemplary aspect of the present disclosure that includes a wireless IC chip; a power feeding circuit board including a terminal electrode to which the wireless IC chip is connected; an article; and a conductive thread for attaching the power feeding circuit board to the article. Moreover, the conductive thread is configured to contact the terminal electrode and function as a radiator while the power feeding circuit board is attached to the article.

According to the exemplary embodiments of the present disclosure, an article with the wireless communication device is provided in which the wireless communication device is attached to the article without using an adhesive.

### BRIEF DESCRIPTION OF DRAWINGS

FIG. 1 is a schematic perspective diagram of an article with a wireless communication device according to a first exemplary embodiment.

FIG. 2 is a schematic configuration diagram of the article with a wireless communication device of FIG. 1.

FIG. 3 is a diagram showing a specific configuration example of the article with a wireless communication device of FIG. 2.

FIG. 4 is a diagram showing a specific configuration example of the article with a wireless communication device of FIG. 2.

FIG. 5 is a diagram showing a specific configuration example of the article with a wireless communication device of FIG. 2.

FIG. 6 is a diagram showing a modification of a specific configuration of the article with a wireless communication device of FIG. 2.

FIG. 7 is a schematic configuration diagram of an article with a wireless communication device according to a second exemplary embodiment.

FIG. 8 is a diagram showing a specific configuration example of the article with a wireless communication device of FIG. 7.

FIG. 9 is a schematic configuration diagram of an article with a wireless communication device according to a third exemplary embodiment.

FIG. 10 is a diagram showing a specific configuration example of the article with a wireless communication device of FIG. 9.

FIG. 11 is a diagram showing a specific configuration example of the article with a wireless communication device of FIG. 9.

FIG. 12 is a diagram showing a specific configuration example of the article with a wireless communication device of FIG. 9.

FIG. 13 is a diagram showing a specific configuration example of the article with a wireless communication device of FIG. 9.

FIG. 14 is a schematic configuration diagram of an article with a wireless communication device according to a fourth exemplary embodiment.

FIG. 15 is a diagram showing a specific configuration example of the article with a wireless communication device of FIG. 14.

FIG. 16 is a diagram showing a modification of a specific configuration of the article with a wireless communication device of FIG. 14.

### DETAILED DESCRIPTION

An exemplary aspect of the present invention provides an article with a wireless communication device that includes a wireless IC chip; a power feeding circuit board including a terminal electrode to which the wireless IC chip is connected; an article; and a conductive thread for attaching the power feeding circuit board to the article. Moreover, the conductive thread is in contact with the terminal electrode and functions as a radiator while the power feeding circuit board is attached to the article.

According to this configuration, the conductive thread is used as the radiator, and the power feeding circuit board is attached to the article by the conductive thread, so that the wireless communication device can be attached to the article without using an adhesive.

In an exemplary aspect, the conductive thread can have a portion penetrating the power feeding circuit board to the inside of the article. According to this configuration, the power feeding circuit board and the article can more firmly be attached by the conductive thread.

In an exemplary aspect, the conductive thread can be sewn to the article via the power feeding circuit board so as to have multiple portions penetrating the power feeding circuit board to the inside of the article. According to this configuration, the power feeding circuit board and the article can more firmly be attached by the conductive thread.

In an exemplary aspect, the terminal electrode can include a first electrode and a second electrode arranged at an interval from each other, and the conductive thread can include a first thread in contact with the first electrode and a second thread in contact with the second electrode. According to this configuration, the radiation characteristics can be improved as compared to a configuration in which one conductive thread is brought into contact with one terminal electrode.

In an exemplary aspect, the terminal electrode can include an inner electrode connected to the wireless IC chip and an outer electrode disposed such that magnetic field coupling to the inner electrode can be achieved, and the conductive thread can be in contact with the outer electrode and may function as a radiator while the power feeding circuit board is attached to the article.

In an exemplary aspect, the inner electrode can be a loop-shaped or spiral-shaped electrode, the outer electrode can be an electrode arranged at an interval from the inner electrode, and the conductive thread can be sewn to the article via at least a portion of the outer electrode.

In an exemplary aspect, the outer electrode can be a loop-shaped electrode arranged to surround the inner electrode.

In an exemplary aspect, the outer electrode can be provided with a slit dividing a portion of the loop-shaped electrode.

By the conductive thread, the power feeding circuit board can be attached to the article in a portion on one end side of the conductive thread.

Moreover, a non-conductive thread for attaching the power feeding circuit board to the article can further be included.

In one aspect, the article can be an article of clothing.

Exemplary embodiments of the present invention will now be described with reference to the drawings. The present invention is not limited to these embodiments. In the drawings, substantially the same members are denoted by the same reference numerals.

### First Exemplary Embodiment

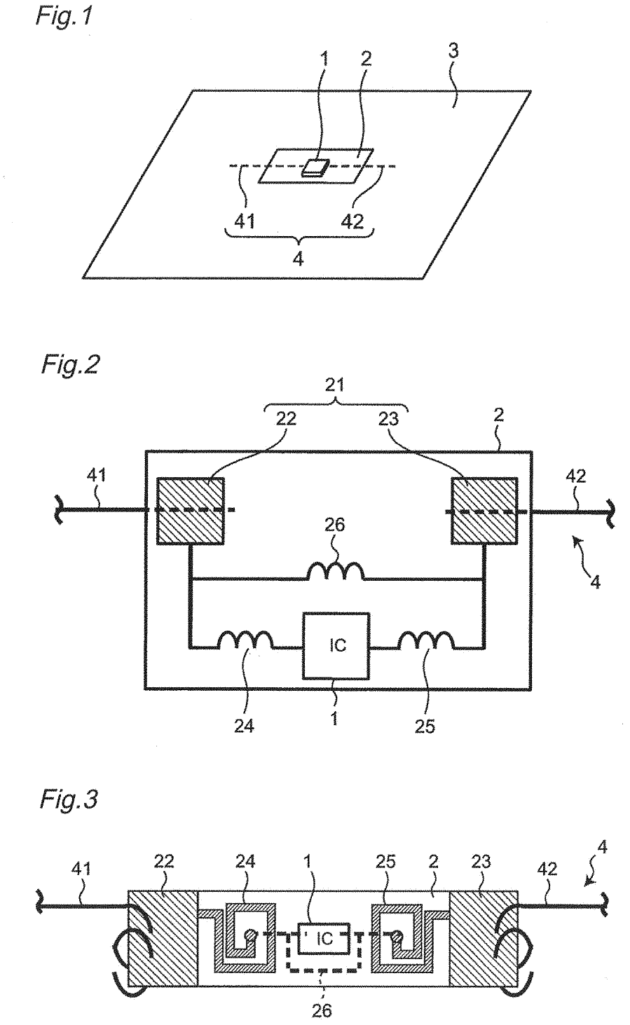

FIG. 1 is a schematic perspective diagram of an article with a wireless communication device according to a first exemplary embodiment. FIG. 2 is a schematic configuration diagram of the article with a wireless communication device of FIG. 1.

As shown in FIG. 1, the article with a wireless communication device includes a wireless IC chip 1, a power feeding circuit board 2, an article 3, and a conductive thread 4. In the first embodiment, the wireless communication device is formed by the wireless IC chip 1, the power feeding circuit board 2, and the conductive thread 4.

The wireless IC chip 1 is a chip-shaped component for processing a transmission/reception signal of a predetermined frequency (e.g., UHF band, HF band). In this embodiment, the wireless IC chip 1 can be an RFIC (Radio-Frequency Integrated Circuit) chip corresponding to a communication frequency in the UHF band (860 MHz to 960 MHz). Moreover, the wireless IC chip 1 includes a pair of input/output terminals (not shown).

As shown in FIG. 2, the power feeding circuit board 2 has a terminal electrode 21 to which the wireless IC chip 1 is connected. In the first embodiment, the terminal electrode 21 includes a first electrode 22 and a second electrode 23 arranged at an interval from each other. One of the input/output terminals of the wireless IC chip 1 is electrically connected via a first inductor element 24 to the first electrode 22. The other input/output terminal of the wireless IC chip 1 is electrically connected via a second inductor element 25 to the second electrode 23. As further shown, a third inductor element 26 is connected in parallel to the first inductor element 24 and the second inductor element 25. In an exemplary aspect, the first electrode 22 and the second electrode 23 have a rectangular outer size of 2 mm×3 mm in planar view, for example. Moreover, the power feeding circuit board 2 has a rectangular outer size of 10 mm×5 mm in planar view, for example.

In the first embodiment, the first inductor element 24, the second inductor element 25, and the third inductor element 26 form a matching circuit configured to match impedance between the conductive thread 4 functioning as a radiator (e.g., an antenna) and the wireless IC chip 1. When the conductive thread 4 receives a high-frequency signal from the outside, the wireless IC chip 1 is activated by receiving supply of a current induced by the reception. The activated wireless IC chip 1 generates a high-frequency signal and outputs the generated signal as a radio wave via the conductive thread 4 to the outside.

The article 3 is an article to which the power feeding circuit board 2 can be attached by using the conductive thread 4. In the first embodiment, the article 3 is an article of clothing. It is noted that in the drawings of FIGS. 2 to 16, the article 3 is not shown.

In an exemplary aspect, the conductive thread 4 is a conductive thread-shaped or fiber-shaped member for attaching the power feeding circuit board 2 to the article 3. The conductive thread 4 is in contact with the terminal electrode 21 and functions as a radiator while the power feeding circuit board 2 is attached to the article 3. In the first embodiment, the conductive thread 4 includes a first thread 41 in contact with the first electrode 22 and a second thread 42 in contact with the second electrode 23.

The first thread 41 and the second thread 42 are each attached so as to have a portion penetrating the power feeding circuit board 2 to the inside of the article 3. In the first embodiment, the first thread 41 and the second thread 42 are sewn to the article 3 via the power feeding circuit board 2 so as to have multiple portions penetrating the power feeding circuit board 2 to the inside of the article 3. More specifically, the first thread 41 and the second thread 42 are sewn with running stitches to the article 3 via the power feeding circuit board 2. The first thread 41 is sewn to the article 3 so as to penetrate the first electrode 22, thereby coming into contact with the first electrode 22 and functioning as a radiator. Similarly, the second thread 42 is sewn to the article 3 so as to penetrate the second electrode 23, thereby coming into contact with the second electrode 23 and functioning as a radiator.

FIGS. 3 to 5 are diagrams showing specific configuration examples of the article with a wireless communication device of FIG. 2.

In the configuration example shown in FIG. 3, the power feeding circuit board 2 is a double-sided flexible board in which conductor patterns are formed on both principal surfaces. The first inductor element 24 and the second inductor element 25 are formed by spiral coils formed on one principal surface of the power feeding circuit board 2. The third inductor element 26 is formed by a conductor pattern formed on the other principal surface of the power feeding circuit board 2. The first electrode 22 is formed at one longitudinal end portion of the power feeding circuit board 2. The second electrode 23 is formed at the other longitudinal end portion of the power feeding circuit board 2. The first thread 41 is sewn with whip stitches to the article 3 via the first electrode 22. The second thread 42 is sewn with whip stitches to the article 3 via the second electrode 23.

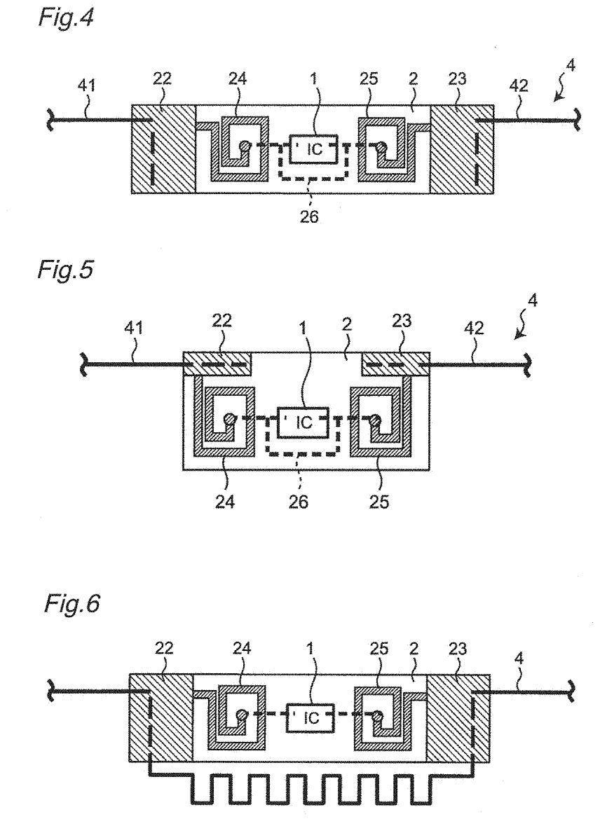

The configuration example shown in FIG. 4 is different from the configuration example shown in FIG. 3 in that the first thread 41 is sewn with running stitches to the article 3 via the first electrode 22 and that the second thread 42 is sewn with running stitches to the article 3 via the second electrode 23.

The configuration example shown in FIG. 5 is different from the configuration example shown in FIG. 4 in that the first electrode 22 and the second electrode 23 are respectively formed at corner portions of the power feeding circuit board 2.

According to the first embodiment, the conductive thread 4 is used as the radiator, and the power feeding circuit board 2 is attached to the article 3 by the conductive thread 4. As a result, the wireless communication device can be attached to the article 3 without using an adhesive.

According to the first embodiment, the conductive thread 4 has a portion penetrating the power feeding circuit board 2 to the inside of the article 3. As a result, the power feeding circuit board 2 and the article 3 can more firmly be attached by the conductive thread 4.

According to the first embodiment, the conductive thread 4 is sewn to the article 3 via the power feeding circuit board 2 so as to have multiple portions penetrating the power feeding circuit board 2 to the inside of the article 3. As a result, the power feeding circuit board 2 and the article 3 can more firmly be attached by the conductive thread 4. Additionally, by sewing the conductive thread 4 to the article 3 via the terminal electrode 21, multiple points of the conductive thread 4 can be brought into contact with the terminal electrode 21, so that the conductive thread 4 can more reliably conductively connected to the terminal electrode 21.

According to the first embodiment, the terminal electrode 21 includes the first electrode 22 and the second electrode 23 arranged at an interval from each other, and the conductive thread 4 includes the first thread 41 in contact with the first electrode 22 and the second thread 42 in contact with the second electrode 23. According to this configuration, the antenna characteristics can be improved as compared to the configuration in which the one conductive thread 4 is brought into contact with the one terminal electrode 21.

Although the conductive thread 4 includes the first thread 41 and the second thread 42 in the above description, it is noted that the present invention is not limited thereto. For example, as shown in FIG. 6, the conductive thread 4 may be a single thread-shaped or fiber-shaped member and may be sewn to the article 3 via the power feeding circuit board 2 so as to come into contact with both the first electrode 22 and the second electrode 23. According to this configuration, the power feeding circuit board 2 can more easily be attached to the article 3 by the conductive thread 4. In this case, a portion of the conductive thread 4 located between the first electrode 22 and the second electrode 23 can be made longer by a meandering shape or the like so as to suppress a short circuit between the first electrode 22 and the second electrode 23.

Although the power feeding circuit board 2 includes the matching circuit in the above description, the present invention is not limited thereto. The power feeding circuit board 2 may not include a matching circuit in an alternative aspect. For example, the matching circuit may be formed through patterning by using the conductive thread 4.

Although running stitching and whip stitching are described as examples of a sewing method of sewing the conductive thread 4 to the article 3 via the power feeding circuit board 2 in the above description, it is noted that the exemplary embodiment is not limited thereto. A wide variety of sewing methods can be adopted as the sewing method of the conductive thread 4.

Although the power feeding circuit board 2 is attached to the article 3 by using only the conductive thread 4 in the above description, the exemplary embodiment is not limited thereto. For example, the power feeding circuit board 2 may be attached to the article 3 by using the conductive thread 4 and a non-conductive thread in combination.

Although the power feeding circuit board 2 is a double-sided flexible board in the above description, the exemplary embodiment is not limited thereto. For example, the power feeding circuit board 2 may be a hard board such as a ceramic board. In this case, a through-hole may be disposed in advance in the board so that the conductive thread 4 or a needle attached to the conductive thread 4 can easily penetrate the board. For example, the power feeding circuit board 2 may be made up of a board having a laminated structure in which the terminal electrode 21 is formed over multiple layers. According to this configuration, the conductive thread 4 penetrates the terminal electrode 21 over multiple layers, so that the conductive thread 4 and the terminal electrode 21 can more reliably be made conductive to each other.

Although the conductive thread 4 is sewn to the article 3 via the power feeding circuit board 2 with the terminal electrode 21 exposed to the outside in the above description, the exemplary embodiment is not limited thereto. For example, the conductive thread 4 may be sewn to the article 3 via the power feeding circuit board 2 with the terminal electrode 21 covered with a resist film. According to this configuration, since the terminal electrode 21 is not exposed to the outside, water resistance and durability can be improved.

Although the conductive thread 4 is sewn to the article 3 via the power feeding circuit board 2 so as to have multiple portions penetrating the power feeding circuit board 2 to the inside of the article 3 in the above description, the exemplary embodiment is not limited thereto. For example, if a mechanism of attaching the power feeding circuit board 2 and the article 3 exists other than the conductive thread 4 (e.g., if a non-conductive thread exists), the conductive thread 4 may simply be attached in contact with the terminal electrode 21 without penetrating the power feeding circuit board 2.

### Second Exemplary Embodiment

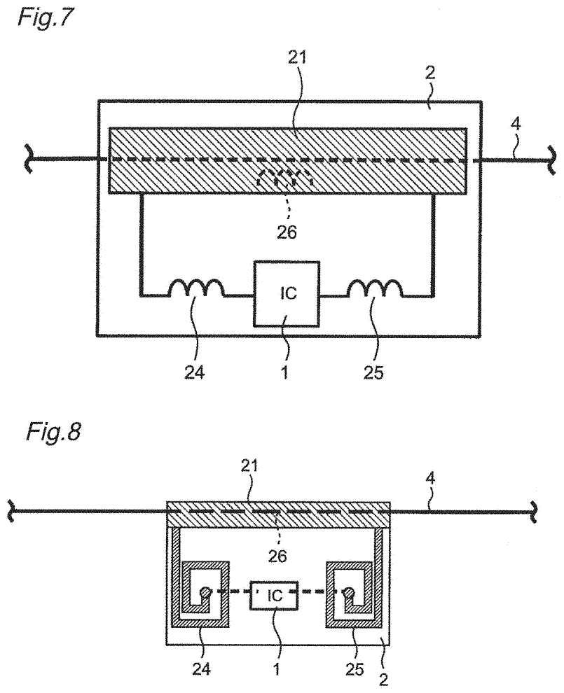

FIG. 7 is a schematic configuration diagram of an article with a wireless communication device according to a second exemplary embodiment.

A main difference of the article with a wireless communication device according to the second embodiment from the article with a wireless communication device according to the first embodiment described above is that the terminal electrode 21 is made up of an electrode having a large aspect ratio and that one conductive thread is used as the conductive thread 4.

As shown in FIG. 7, when the terminal electrode 21 is formed by an electrode having a large aspect ratio, an inductance component is generated in accordance with the length of the terminal electrode 21, and a potential difference is generated between one end portion and the other end portion of the terminal electrode 21. This potential difference allows the conductive thread 4 to function as a radiator. In the second embodiment, the inductance component generated in accordance with the length of the terminal electrode 21 is used as the third inductor element 26.

In the second embodiment, the terminal electrode 21 has a rectangular outer size of 10 mm×3 mm in planar view, for example. Moreover, the power feeding circuit board 2 has a rectangular outer size of 10 mm×5 mm in planar view, for example.

The conductive thread 4 is sewn to the article 3 via the terminal electrode 21 and thereby brought into contact with the terminal electrode 21 to function as a radiator.

FIG. 8 is a diagram showing a specific configuration example of the article with a wireless communication device of FIG. 7.

In the configuration example shown in FIG. 8, the power feeding circuit board 2 is a double-sided flexible board in which conductor patterns are formed on both principal surfaces. The first inductor element 24 and the second inductor element 25 are formed by spiral coils disposed on one principal surface of the power feeding circuit board 2. The third inductor element 26 is formed by an inductance component generated in accordance with the length of the terminal electrode 21. The terminal electrode 21 is formed along one side of the power feeding circuit board 2 extending in the longitudinal direction. The conductive thread 4 is sewn with running stitches to the article 3 via the terminal electrode 21 entirely in the longitudinal direction.

According to the second embodiment, the conductive thread 4 is used as the radiator, and the power feeding circuit board 2 is attached to the article 3 by the conductive thread 4. As a result, the wireless communication device can be attached to the article 3 without using an adhesive. Since the conductive thread 4 is a single thread-shaped or fiber-shaped member, the power feeding circuit board 2 can more easily be attached to the article 3 by the conductive thread 4. Additionally, by sewing the conductive thread 4 to the article 3 via the terminal electrode 21 entirely in the longitudinal direction, multiple points of the conductive thread 4 are brought into contact with the terminal electrode 21, so that the conductive thread 4 and the terminal electrode 21 can more reliably be made conductive to each other.

### Third Exemplary Embodiment

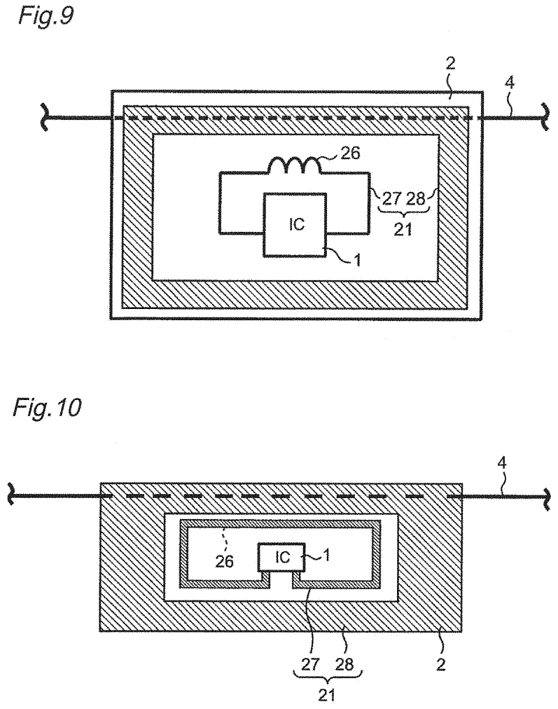

FIG. 9 is a schematic configuration diagram of an article with a wireless communication device according to a third exemplary embodiment.

A main difference between the article with a wireless communication device according to the third embodiment and the article with a wireless communication device according to the first embodiment is that the terminal electrode 21 includes an inner electrode 27 and an outer electrode 28.

The inner electrode 27 is connected to the wireless IC chip 1. In the third embodiment, the inner electrode 27 is a loop-shaped electrode. In the third embodiment, the inductance component of the inner electrode 27 is used as the third inductor element 26. The outer electrode 28 is arranged at an interval from the inner electrode 27 and is disposed such that magnetic field coupling to the inner electrode 27 can be achieved. In the third embodiment, the outer electrode 28 is a loop-shaped electrode arranged at an interval around the inner electrode 27. The conductive thread 4 is in contact with the outer electrode 28 and functions as a radiator while the power feeding circuit board 2 is attached to the article 3. In the third embodiment, the conductive thread 4 is sewn to the article 3 via at least a portion of the outer electrode 28.

FIGS. 10 to 13 are diagrams showing specific configuration examples of the article with a wireless communication device of FIG. 9.

In the configuration example shown in FIG. 10, the power feeding circuit board 2 is a single-sided board having a conductor pattern formed on one principal surface. The inner electrode 27 is formed into a loop shape and is connected to the wireless IC chip 1. The third inductor element 26 is made up of an inductance component of the inner electrode 27. The outer electrode 28 is formed into a loop shape along an outer circumference of the power feeding circuit board 2. The conductive thread 4 is sewn with running stitches to the article 3 via a portion of the terminal electrode 21 along one side of the power feeding circuit board 2 in the longitudinal direction. According to this configuration, since the inner electrode 27 and the outer electrode 28 are close to each other in a wide portion, a degree of magnetic field coupling between the inner electrode 27 and the outer electrode 28 can be increased, and the antenna performance can be improved. Particularly, when the radiator is short, the impedance tends to be capacitive, and therefore, a slit is preferably not disposed so as to use the inductance component of the loop-shaped electrode.

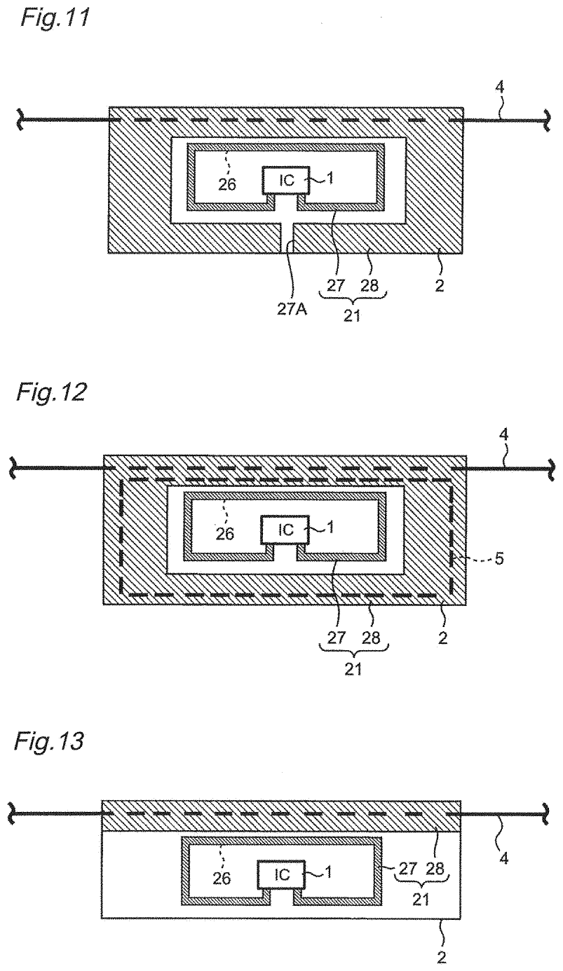

The configuration example shown in FIG. 11 is different from the configuration example shown in FIG. 10 in that the outer electrode 28 is provided with a slit 27A dividing a portion of the loop-shaped electrode. Depending on the size and shape of the power feeding circuit board 2, currents flowing through the outer electrode 28 cancel each other so that the antenna performance may deteriorate. In this regard, according to the configuration, since the slit 27A is disposed, the currents flowing through the outer electrode 28 can be prevented from canceling each other, and the antenna performance can be improved.

The configuration example shown in FIG. 12 is different from the configuration example shown in FIG. 10 in that a non-conductive thread 5 is sewn to the article 3 over the entire circumference of the loop-shaped outer electrode 28. According to this configuration, the power feeding circuit board 2 and the article 3 can more firmly be attached.

According to the third embodiment, the conductive thread 4 is used as the radiator, and the power feeding circuit board 2 is attached to the article 3 by the conductive thread 4. As a result, the wireless communication device can be attached to the article 3 without using an adhesive. Since the conductive thread 4 is a single thread-shaped or fiber-shaped member, the power feeding circuit board 2 can more easily be attached to the article 3 by the conductive thread 4. Additionally, by sewing the conductive thread 4 to the article 3 via the terminal electrode entirely in the longitudinal direction, multiple points of the conductive thread 4 can be brought into contact with the terminal electrode 21, so that the conductive thread 4 and the terminal electrode 21 can more reliably be made conductive to each other. Further, since the inner electrode 27 connected to the wireless IC chip 1 is physically separated from the outer electrode 28 and the conductive thread 4, energy can be transmitted through magnetic field coupling while suppressing an electrical short circuit.

Although the inner electrode 27 is a loop-shaped electrode in the above description, the exemplary embodiment is not limited thereto. For example, the inner electrode 27 may be a spiral-shaped electrode.

Although the outer electrode 28 is a loop-shaped electrode arranged at an interval around the inner electrode 27 in the above description, the present invention is not limited thereto. The outer electrode 28 may be disposed such that magnetic field coupling to the inner electrode 27 can be achieved. For example, as shown in FIG. 13, the outer electrode 28 may be formed along one side of the power feeding circuit board 2 extending in the longitudinal direction.

Although the conductive thread 4 is a single thread-shaped or fiber-shaped member in the above description, the exemplary embodiment is not limited thereto. The conductive thread 4 may be configured to include the first thread 41 and the second thread 42 such that these threads are connected to the terminal electrodes 21 at positions separated from each other.

### Fourth Exemplary Embodiment

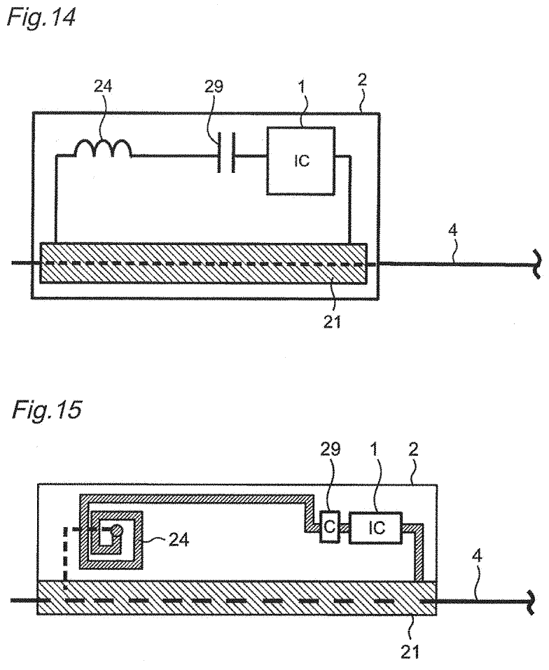

FIG. 14 is a schematic configuration diagram of an article with a wireless communication device according to a fourth exemplary embodiment.

A main difference of the article with a wireless communication device according to the fourth embodiment from the article with a wireless communication device according to the second embodiment is that the power feeding circuit board 2 is attached to the article 3 in a portion on one end side of the conductive thread 4.

In the fourth embodiment, the second inductor element 25 is not disposed, and a capacitor element 29 is connected between the first inductor element 24 and the wireless IC chip 1.

In the fourth embodiment, the terminal electrode 21 has a rectangular outer size of 5 mm×3 mm in planar view, for example. Moreover, the power feeding circuit board 2 has a rectangular outer size of 5 mm×5 mm in planar view, for example.

The portion on one end side of the conductive thread 4 is sewn on the article 3 via the terminal electrode 21 so that the conductive thread 4 comes into contact with the terminal electrode 21 and functions as a radiator.

FIG. 15 is a diagram showing a specific configuration example of the article with a wireless communication device of FIG. 14.

In the configuration example shown in FIG. 15, the power feeding circuit board 2 is a double-sided flexible board in which conductor patterns are formed on both principal surfaces. The first inductor element 24 is made up of a spiral coil formed on one principal surface of the power feeding circuit board 2 and is disposed closer to one end portion of the power feeding circuit board 2. The capacitor element 29 and the wireless IC chip 1 are disposed closer to the other end portion of the power feeding circuit board 2. The terminal electrode 21 is formed along one side of the power feeding circuit board 2 extending in the longitudinal direction. The conductive thread 4 is sewn with running stitches to the article 3 via the terminal electrode 21 entirely in the longitudinal direction.

According to the fourth embodiment, the conductive thread 4 is used as the radiator, and the power feeding circuit board 2 is attached to the article 3 by the conductive thread 4. As a result, the wireless communication device can be attached to the article 3 without using an adhesive. Since the conductive thread 4 is a single thread-shaped or fiber-shaped member, the power feeding circuit board 2 can more easily be attached to the article 3 by the conductive thread 4. Additionally, by sewing the conductive thread 4 to the article 3 via the terminal electrode 21 entirely in the longitudinal direction, multiple points of the conductive thread 4 are brought into contact with the terminal electrode 21, so that the conductive thread 4 and the terminal electrode 21 can more reliably be made conductive to each other. Furthermore, when the power feeding circuit board 2 needs to be shifted toward the one end portion of the conductive thread 4 due to a design restriction of the article 3, this restriction can be dealt with since the portion on the one end side of the conductive thread 4 is sewn to the article 3 via the terminal electrode 21.

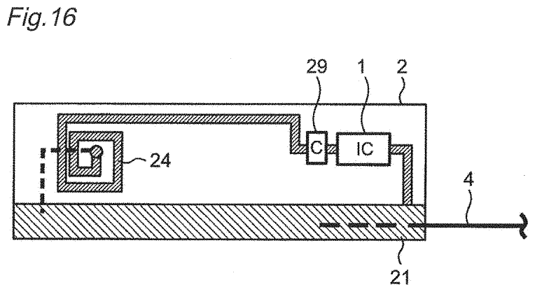

Although the conductive thread 4 is sewn to the article 3 via the terminal electrode 21 entirely in the longitudinal direction in the above description, the present invention is not limited thereto. For example, as shown in FIG. 16, the conductive thread 4 may be sewn to the article 3 only via the one end side of the terminal electrode 21.

Although the exemplary embodiments of the present invention have been described with reference to the accompanying drawings, it is noted that various modifications and corrections should be apparent to those skilled in the art. It should also be understood that such modifications and corrections are included in the present invention without departing from the scope of the present invention.

### EXPLANATIONS OF LETTERS OR NUMERALS

1 wireless IC chip

2 power feeding circuit board

3 article

4 conductive thread

5 non-conductive thread

21 terminal electrode

22 first electrode

23 second electrode

24 first inductor element

25 second inductor element

26 third inductor element

27 inner electrode

28 outer electrode

27A slit

29 capacitor element

41 first thread

42 second thread

1. An article with a wireless communication device comprising:
a wireless IC chip;
a power feeding circuit board that includes a terminal electrode connected to the wireless IC chip;
an article; and
a conductive thread that attaches the power feeding circuit board to the article,
wherein the conductive thread is constructed to contact the terminal electrode and configured to function as a radiator when the power feeding circuit board is attached to the article.

2. The article with the wireless communication device according to claim 1, wherein the conductive thread has a portion that penetrates the power feeding circuit board to an inside of the article.

3. The article with the wireless communication device according to claim 1, wherein the conductive thread is sewn to the article via the power feeding circuit board so as to have a plurality of portions that penetrate the power feeding circuit board to an inside of the article.

4. The article with the wireless communication device according to claim 1,
wherein the terminal electrode comprises a first electrode and a second electrode arranged at an interval from each other, and
wherein the conductive thread comprises a first thread in contact with the first electrode and a second thread in contact with the second electrode.

5. The article with the wireless communication device according to claim 4, wherein the power feeding circuit board comprises a first inductor element that connects the first electrode to the wireless IC chip and a second inductor element that connects the second electrode to the wireless IC chip.

6. The article with the wireless communication device according to claim 5, wherein the power feeding circuit board further comprises a third inductor element connected in parallel to the first inductor element and the second inductor element.

7. The article with the wireless communication device according to claim 6,
wherein the power feeding circuit board is a double-sided flexible board,
wherein the first and second inductor elements comprise spiral coils disposed on a first principal surface of the power feeding circuit board, and
wherein the third inductor element comprises a conductor pattern disposed on a second principal surface of the power feeding circuit board that is opposite the first principal surface.

8. The article with the wireless communication device according to claim 4, wherein the first thread is sewn with whip stitches to the article via the first electrode and the second thread is sewn with whip stitches to the article via the second electrode.

9. The article with the wireless communication device according to claim 4, wherein the first thread is sewn with running stitches to the article via the first electrode and the second thread is sewn with running stitches to the article via the second electrode.

10. The article with the wireless communication device according to claim 1,
wherein the terminal electrode comprises an inner electrode connected to the wireless IC chip and an outer electrode disposed to form a magnetic field coupling to the inner electrode, and
wherein the conductive thread is in contact with the outer electrode and is configured to functions as a radiator when the power feeding circuit board is attached to the article.

11. The article with the wireless communication device according to claim 10,
wherein the inner electrode is a loop-shaped or spiral-shaped electrode,
wherein the outer electrode is an electrode arranged at an interval from the inner electrode, and
wherein the conductive thread is sewn to the article via at least a portion of the outer electrode.

12. The article with the wireless communication device according to claim 11, wherein the outer electrode is a loop-shaped electrode arranged to surround the inner electrode.

13. The article with the wireless communication device according to claim 12, wherein the outer electrode comprises a slit that divides a portion of the loop-shaped electrode to prevent respective currents flowing through the outer electrode from canceling each other.

14. The article with the wireless communication device according to claim 1, wherein the conductive thread attaches the power feeding circuit board to the article in a portion on one end side of the conductive thread.

15. The article with the wireless communication device according to claim 1, further comprising a non-conductive thread constructed to attach the power feeding circuit board to the article.

16. The article with the wireless communication device according to claim 1, wherein the article is clothing.

17. The article with the wireless communication device according to claim 1,
wherein the terminal electrode comprises a first electrode and a second electrode arranged at an interval from each other, and
wherein the conductive thread comprises a single thread-shaped or a fiber-shaped member that is sewn to the article via the power feeding circuit board to contact both the first electrode and the second electrode.

18. The article with the wireless communication device according to claim 17, wherein a portion of the conductive thread between the first and second electrodes comprises a meandering shape to prevent a short circuit between the first and second electrodes.

19. A wireless communication device comprising:
a wireless IC chip;
a power feeding circuit board that includes at least one terminal electrode connected to the wireless IC chip; and
a conductive thread that is constructed to attach the power feeding circuit board to an article of clothing,
wherein the conductive thread is constructed to contact the at least one terminal electrode and is configured to function as a radiator when the power feeding circuit board is attached to the article.

20. The wireless communication device according to claim 19, wherein the conductive thread has a portion that penetrates the power feeding circuit board to an inside of the article.
